(19) United States
(12) Patent Application Publication
(10) Pub. No.: US 2021/0349023 A1
(43) Pub. Date: Nov. 11, 2021

(54) BIOMARKER READER

(71) Applicant: ams AG, Premtaetten (AT)

(72) Inventors: Filip Frederix, Premstaetten (AT); Remco Verdoold, Premstaetten (AT); Erik Jan Lous, Premstaetten (AT)

(21) Appl. No.: 17/273,214

(22) PCT Filed: Sep. 4, 2019
(86) PCT No.: PCT/EP2019/073625

§ 371 Date: Mar. 3, 2021

Related U.S. Application Data
(60) Provisional application No. 62/726,623, filed on Sep. 4, 2018.

(51) Int. Cl. G01N 21/64; G01N 21/76; G01N 21/78

(52) U.S. Cl. CPC G01N 21/6408; G01N 21/76; G01N 2021/7773; G01N 2021/6421; G01N 21/78

(57) ABSTRACT

Apparatus for reading a test region (6, 7) of an assay, e.g. on a lateral flow test strip (5), the apparatus comprising: an optical detector (2, 4; FIG. 1c), comprising an optical input for receiving light emitted from the test region (6, 7) of the assay and an electrical output; an electrical signal processor, electrically coupled to the electrical output; and a plurality of spectral filters (FIG. 1b) substantially transparent to a plurality of different wavelengths.

### FIELD OF TECHNOLOGY

The present disclosure relates to optical readout of diagnostic tests and, in particular, spectral sensors as readout devices for lateral flow tests.

### BACKGROUND

Diagnostic tests are commonly used for identifying diseases. A diagnostic test may be carried out in a central laboratory, whereby a sample, for example blood, is taken from a patient and sent to the central laboratory where the sample is analysed. A different setting for processing samples is at the point where care for the patient is delivered, which is referred to as point-of-care (POC) tests. POC tests allow for a faster diagnosis. Within the POC tests, different technology platforms can be used. A first class of POC tests are high end, microfluidic-based POC tests. These POC tests are mainly used in a professional environment such as hospitals or emergency rooms. A different technology platform is provided by lateral flow test technology. Lateral flow tests are mostly used in the consumer area, such as for pregnancy tests, and are easy to produce and very cost-effective.

Lateral flow tests are very well known as such, but are briefly described by way of background. A lateral flow assay includes a series of capillary beds, such as pieces of porous paper, nitrocellulose membranes, microstructured polymer, or sintered polymer for transporting fluid across a series of pads by capillary forces. A sample pad acts as a sponge and is arranged to receive a sample fluid, and further holds an excess of the sample fluid. After the sample pad is saturated with sample fluid, the sample fluid migrates to a conjugate pad in which the manufacturer has stored the so-called conjugate. The conjugate is a dried format of bio-active particles in a salt-sugar matrix intended to create a chemical reaction between the target molecule (e.g., an antigen) and its chemical partner (e.g. antibody or receptor). While the sample fluid dissolves the salt-sugar matrix, it also mobilizes the bio-active particles and in one combined transport action the sample and conjugate mix with each other while flowing through the capillary beds. The analyte binds to the particles while migrating further through the third capillary bed. This material has one or more areas, which are called stripes, where a third type of molecule has been immobilized by the manufacturer, in most cases an antibody or receptor addressed against another part of the antigen. By the time the sample-conjugate mix reaches these strips, analyte has been bound on the particle and the third type of molecule binds the complex. When more fluid has passed the stripes, particles accumulate on the stripes and the stripes become visible, appear or are generated in a particular colour or with a fluorescent wavelength capability. In this way the stripe is optically detectable by colour or by fluorescent emission detection, respectively.

Typically, there are at least two stripes: a control stripe/line that captures the conjugate and thereby shows that reaction conditions and technology work, and a second stripe, the test stripe/line, that contains a specific capture molecule and only captures those particles onto which an analyte or antigen molecule has been immobilized. This makes the diagnostic result of the test visible for the patient. Some test results rely on the presence of fluorescent particles, which may not be visible to the user but can instead be detected by optical detectors when the stripes are illuminated. After passing the different reaction zones, the fluid enters the final porous material, which is a wick that acts as a waste container.

The lateral flow test strip can contain multiple test lines, where each test line contains a different type of specific capture molecule, which binds to a different analyte or antigen. This multi-analyte detection, using spatially separated test lines, can be done using the same colour or fluorescent emission wavelength for the optical detection. However, each test line can also be made visible by different colours or fluorescent emission wavelength. For example, each type of specific receptor bound to its respective analyte-conjugate complex may have a different colour or emission wavelength. Ultimately, these test lines can be one line, not spatially separated, on the lateral flow test strip, but can be spectrally separated by the different colours or emission wavelengths.

In summary, lateral flow tests as such are well known and have four key elements: the antibody, the antigen, the conjugate and the complex. Despite these key elements being well established, the terminology used by the skilled person is not always consistent and different terms may refer to the same element. The antibody is also referred to as receptor, chemical partner, or capture molecule. The antigen is also referred to as analyte, target molecule, antigen molecule, target analyte or biomarkers. The sample typically contains the analyte, although that is not always the case. The conjugate is also referred to as (analyte) tags, tagging particles, chemical partner, (sample) conjugate mix, bioactive particles or conjugate receptors. Examples of conjugates are fluorescent particles, red particles or dyes, and further examples are provided in the specific description. The complex is the combination of the antigen and conjugate. The complex is also referred to as tagged analyte, or particles onto which the analyte molecule has been immobilised.

### STATEMENT OF INVENTION

According to a first aspect of the invention, there is provided an apparatus for reading a test region of an assay, the apparatus comprising: an optical detector, comprising an optical input for receiving light emitted from the test region of the assay and an electrical output; an electrical signal processor, electrically coupled to the electrical output; and a plurality of spectral filters substantially transparent to a plurality of different wavelengths.

The spectral filters may be arranged in front of the optical input of the optical detector and the plurality of spectral filters may correspond to a plurality of spatially separated regions of the optical detector. Optionally, the optical detector comprises a main optical axis for receiving an incoming optical signal, and wherein the plurality of regions are arranged in a plane substantially perpendicular to the main optical axis.

The plurality of spectral filters may further comprise a reference portion, which has an optical transmission spectrum which is broader than the transmission spectrum of said plurality of different wavelengths. The reference portion can be used to measure the background light signal.

The optical detector may be a spatially resolved optical detector with a spatial resolution larger than the number of said plurality of spectral filters. For example, the optical detector may comprise an array of detectors, and each detector of the array of detectors may correspond to each of said plurality of spectral filters.

The optical detector may comprises said plurality of spectral filters, and in that case the spectral filters are not a separate component.

The apparatus may further comprise a light source for illuminating the test region. The optical detector may further comprise a field of view, and the light source may be arranged outside the field of view of the optical detector.

The apparatus may further comprise an optical component arranged to block a portion of the light emitted or reflected from the test region of the assay. For example, the optical component can be a diaphragm.

The apparatus may further comprise a device for measuring lateral displacement of the test region. Examples of the device for measuring lateral displacement of the test region are: a wheel, a ball or an optical tracking device.

According to a second aspect of the invention there is provided a method for reading a test region of an assay, the method comprising: providing the test region of the assay in the field of view of an optical detector, filtering light emitted from the test region using a plurality of optical filters with different transmission spectra to provide filtered light; detecting the filtered light with the optical detector.

The method may further comprise spectrally resolving transmitted light corresponding to the plurality of different transmission spectra with the optical detector.

The method may further comprise measuring a background optical signal using a filter with a broadband transmission spectrum. The method may further comprise illuminating the test region.

The method may further comprise moving the test region with respect to the optical detector and measuring a time dependency of the filtered light.

The step of detecting the filtered light may further comprise detecting a fluorescence signal, which is optionally time resolved.

### FIGURES

Some embodiments of the invention will now be described by way of example only and with reference to the accompanying drawings, in which:

FIG. 1 is a schematic illustration of an apparatus for reading a test region of an assay;

FIG. 2 is a perspective view of a schematic illustration of an apparatus for reading a test region of an assay;

FIG. 3 is a schematic illustration of an apparatus for reading a test region of an assay;

FIG. 4 is a perspective view of a schematic illustration of an apparatus for reading a test region of an assay; and

FIG. 5 is a flow diagram of a method.

### DETAILED DESCRIPTION

Lateral flow assays or other types of assays indicate the presence of a target molecule by the change of colour characteristics of a test region of the assay. The user can observe the change or appearance of colour by eye and a binary observation can be made whether or not a change of colour has taken place, assuming the change of colour is strong enough to observe. It will generally be very challenging or impossible to quantify the change of colour by eye.

The inventors have realised that an optical detector can be used for measuring and quantifying the change of colour characteristics of a test region of the assay, whereby a colour filter is used to discriminate between the colour change corresponding to the transmission wavelength of the colour filter and other colour changes. For multi-analyte detection, multiple different colour filters are used to discriminate between a plurality of different possible colour changes of the test line of the assay. The filter may be external to the optical detector, or the optical detector may be wavelength sensitive and thereby include the optical filter. The detector can be an array of photodiode pixels, whereby some of the pixels have a different coating than other pixels to filter incoming light selectively.

The test region of the assay may be a flow membrane with reaction regions, for example reaction lines, but the reaction region on the membrane may also be in the form of a circle, dot, or any other shape. Moreover, the reaction region can be a matrix of dots or can be referred to in general as test sites.

An optical detector is arranged with respect to the test region such that the test region is in the field of view of the optical detector. The light source may be arranged outside the field of view of the optical detector to minimise noise that might otherwise be caused by direct illumination of the optical detector with the light source. Additionally, or alternatively, noise caused by the reflectance of areas around the test and control lines on the lateral flow test strip can be reduced by minimising this reflectance. This may be achieved, for example, by arranging one or more optical components such as diaphragms, slits, walls, and/or other blocks in the optical path between the test region and the optical detector to reduce and/or block undesired light reflected from the areas around the test and control lines from reaching the optical detector. The test region may be on-axis or off-axis for the field of view of the detector. A planar optical detector may be used. Examples of optical detectors are a silicon photodiode array, an organic photodiode array, a CCD, a CMOS imaging device, or a single photon avalanche detector (SPAD).

The test region changes colour depending on the presence of a particular analyte. In a specific example of a lateral flow assay, the sample will first flow through a conjugate pad with different analyte tags, and the tagged analyte will then reach the test region where receptors will bind to the analyte, thereby fixing the analyte and tags at the test region. Multiple different types of receptors can be provided within the same test region in a specific embodiment. Alternatively, the different types of receptors are provided in separate test regions or mixed in one region (not spatially separated). When the receptor are provided within the same test region, the presence of multiple corresponding analytes will result in a mixture of different colours.

Illumination of the test region is provided such that the optical detector is able to detect the colour or colours of the test region. The light source can be one or more of: a light emitting diode (LED), a halogen lamp, an organic light emitting diode (OLED), a vertical-cavity surface-emitting laser (VCSEL), a laser diode, or any other suitable light source. The light source may have a narrow spectrum or a broad spectrum. The light source may be a pulsed or continuous light source. The choice of light source depends on the type of emission or reflection from the test region which is detected.

In an alternative configuration, absorbance of test lines and control lines can be measured where the lateral flow test strip is positioned between the light source and the optical detector.

Exemplary configurations of the above techniques will now be described. These configurations are not intended to be limiting and it is envisaged that elements of each configuration may be combined with each other.

A first example uses reflection of light. The test region is illuminated with a broadband light source and the reflected spectrum and its intensity (quantification) depends on the presence of analytes. A lateral flow assay whereby a user or optical detector as described above observes the presence of coloured stripes is an example of reflection of light. For example, a red stripe will be caused by the reflection of red light and absorption of other parts of the white light spectrum which is used to illuminate the sample. An analyte can therefore also be detected by a reduction rather than an increase in reflection, for example when less blue light is reflected from a test region which has an increased presence of red particles.

A second example is fluorescence. The sample region is illuminated with light having a narrow spectrum centred around a first wavelength, which is the excitation wavelength, and when an analyte is present the sample will emit light at one or more longer wavelengths than the excitation wavelength, (or smaller wavelengths when downconverting dyes are used). When multiple different analytes are present, one or more excitation wavelengths can be used and multiple different emission wavelengths can be monitored. The measurement can be a fluorescence measurement with the advantage of increased sensitivity when compared to measurement of reflected light from the test region. The test region can also be illuminated with pulsed broadband light when fluorescence measurements are used. Pulse excitations can reveal time dependent fluorescence information. The detection of the fluorescence can be a time-resolved detection, or can be carried out without time resolved detection but with filtering the light to block the excitation light.

A third example of a type of emission which can be monitored is (chemi-) luminescence. This luminescence is spontaneous emission from the test region due to a chemical reaction. If luminescence is monitored, no excitation light will be required and a light source may be omitted. The chemical reactions are chosen such that different analytes have different emission wavelengths which can be distinguished from each other.

In each of the examples of types of emission, different analytes are identified by detecting different emission wavelengths. The tagging particles are typically selected to carry out the emission function. The term emission used herein refers to the emission of light in general from the test region and includes the example of reflection of light. Examples of tagging particles are gold nanoparticles, polystyrene particles, quantum dots, fluorescence labels or chemiluminescent labels. In one embodiment, the distinction between wavelengths is achieved by using different optical filters, which are placed before the detector. The different filters are arranged adjacent to each other in the plane parallel to the front surface of the detector. The presence of an analyte which gives rise to the emission of a first wavelength is detected by transmission through the particular filter which is transparent for the first wavelength, while the emission is blocked by filters which are transparent to the other wavelengths.

The optical detector which is placed behind the filters is able to detect which of the filters transmits light, for example by including an array of sensors. Instead of filters, a colour sensitive detector can be used and the detector can be considered as incorporating the filter by being able to spectrally resolve the signal.

The test region does not need to be imaged onto the detector surface because the distinguishing feature between different analytes is the difference in colours. The emitted light can therefore be scattered and can be incoherent. Optionally, a lens may be used to collect more light. As described above, the test regions of multiple analytes can overlap partially or completely and/or can be arranged adjacent to each other.

It is envisaged that the filters have transmission peaks at wavelengths corresponding to emission or reflection spectrum peaks of the analytes present on the lateral flow test strip being imaged. In addition, a reference filter can be included to calibrate the colour filters. The reference filter can be a broadband filter or the absence of a filter. For example and the calibration may include subtracting the detected light intensity in the sensor region behind the reference filter from the detected light intensity in the other regions behind the other, colour filters.

In addition, the bare lateral flow test strip can be measured to calibrate for the bare reflection or emission therefrom.

Furthermore, reference diodes can be used to calibrate against the light intensity used to either generate the reflection or to excite the fluorescent markers of the bonded analytes.

As described above, the test region, which can accommodate multiple analytes, combined with the array of different filters enables simultaneous detection of multiple analytes. The signal can also be time resolved to detect reaction dynamics.

In all embodiments described herein, the change of the test lines and control lines can be monitored in time while the lateral flow test strip is loaded with the sample fluid containing the analytes. This gives additional information about the dynamics of the diagnosis and completion of the analysis on the lateral flow test strip.

In the above configuration, the lateral flow test strip and detector are described to be in a fixed position relative to each other. Alternatively, the lateral flow test strip can also be moved over the detector region and tracked, as will be described below, for example, like a computer mouse's displacement may be tracked.

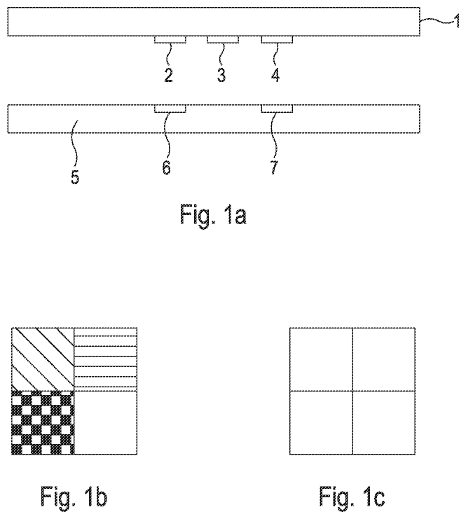

FIG. 1 illustrates an embodiment. A printed circuit board 1 (PCB) holds a first detector 2, an LED light source 3, and a second detector 4. The PCB is placed above a lateral flow test strip 5, which includes test zones 6 and 7. Each one of test zones 6 and 7 are capable of binding a predetermined number (for example three) tagged analytes. FIG. 1b illustrates a filter which covers detector 2, and the same filter covers detector 4. The filter includes four different zones: three filters which transmit three different parts of the optical spectrum and a fourth part which is transparent to a broad range of wavelengths including those of the three filters for providing a reference signal. FIG. 1c illustrates the optical detector behind the filter of FIG. 1b, whereby at least four different zones corresponding to the four sections of the optical filters can be detected, but the resolution is typically higher than the four zones of the filters. An array of sensors can be used, or a single sensor which can spatially resolve the transmitted light. It is envisaged that the number of filter zones may correspond to or be larger than the number of tagged analytes (optionally plus one for the broad wavelength filter). In this way, scalable multiplexing capabilities for any number of analytes may be provided without the need for additional detectors.

The PCB and/or a detector ASIC further comprises processing logic for processing the detected signal. The processing logic can use a reference threshold to provide a binary outcome, whereby a positive test result is provided if the measured signal is above the threshold and whereby a negative test result is provided if the measured signal is below the threshold. However, the processing logic is alternatively able to quantify the strength of the signal. The setup is preferably provided as a compact integrated device into which the sample strip can be inserted.

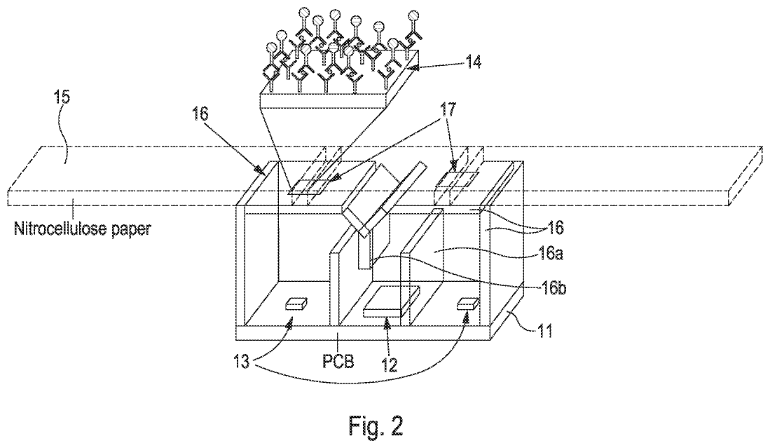

FIG. 2 illustrates the schematic cross section of FIG. 1a in a perspective view, showing additional optional structural features. As in FIG. 1A, the PCB 11 holds a first detector 12, for example a multi spectral sensor, and at least one light source 13, which may be, for example a broadband, white or any other colour LED depending on the illumination requirements of the tagged analytes 14 present on the lateral flow test strip 15, which may be for example for example a nitrocellulose paper strip.

Arranged on the PCB is also one or more walls 16 which divide the space between the PCB 11 and the lateral flow test strip 15 into a plurality of adjoining sections, and which may fully or partially enclose the one or more light sources 13 and detector 12 to shield the detector 12 from light outside of the walls 16. The one or more walls 16 may optionally comprise light absorbing material to reduce unwanted noise caused by e.g. stray reflections inside the walls 16.

One or more of the walls 16 may comprise an aperture 17 to provide an optical path from the at least one light source 13 and detector 12 inside the walls 16 to the lateral flow test strip 15 outside the walls 16. The number of apertures 17 may determine how many test lines or zones may be simultaneously read. Where multiple apertures 17 are present, it is envisaged that multiple light sources 13 may be used. In the non-limiting example of FIG. 2, there are two apertures 17 and corresponding light sources 13 to read simultaneously two lines on the lateral flow test strip 15. Other numbers of apertures and corresponding light sources 13 are also envisaged, such as three, four, five, and more. In this way, even if a lateral flow test strip 15 has multiple test lines or zones with different illumination requirements, they may still be read simultaneously, namely through the use of multiple apertures 17, light sources 13, and/or the spectral filters (not shown in FIG. 2) described above in relation to FIG. 1.

Alternatively and/or additionally, one or more of the walls 16 may be arranged to block a portion of the field of view of the detector 12. For example, a wall 16a may be positioned between the detector 12 and the light source 13 so that the light source is not in the direct field of view of the detector 12. Instead light from the light source 13 only indirectly reaches the detector 12 through reflections and/or emissions from the lateral flow test strip 15. This ensures the detector 12 is not swamped by direct illumination and noise is thereby reduced.

Alternatively and/or additionally, in the case where multiple apertures 17 are present, one or more of the walls 16b may be arranged to prevent light from one aperture 17 interfering with light from the others at the detector 12, which may otherwise cause unwanted noise. For example, the walls 16 may be arranged such that the optical path from one aperture 17 does not intersect that of another. The walls 16 are thus arranged to control what light from different apertures 17 reaches different spatially separated regions of the detector 12.

As described above, the tagged analytes 14 on the test lines or zones on the lateral flow test strip 15 may comprise a plurality of distinctive colour species, for example three different colour species, from which respective binary and/or quantitative measurements of three distinctive analytes may be made.

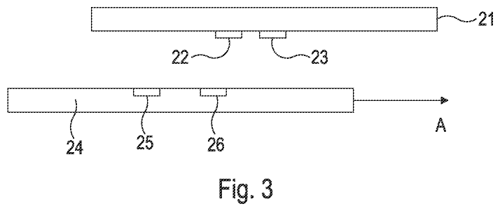

FIG. 3 illustrates a PCB 21 with only a single detector 22 including a filter as illustrated in the embodiment of FIG. 1. A light source 23 is provided on the PCB. Test strip 24 includes again two test zones 25 and 26 capable of binding three different analytes. The two test zones are read out in sequence by moving the lateral flow test strip in the direction indicated by arrow A. Optionally, location tracking is added to be able to ascertain which one of the two test zones is being read out by the PCB and at which speed the lateral flow test strip is moving. An example of a location tracker is a wheel or ball which is pressed against the test strip, whereby the rotation of the wheel or ball is measured and mapped onto the displacement of the test strip. Alternatively, an optical tracking method can be used. These examples of location tracking are known as such and are also used for a computer mouse or a bike wheel when measuring lateral displacement. Additionally, alignment markers can be added to the lateral flow test strip, to indicate for instance a beginning and end of the lateral flow test strip.

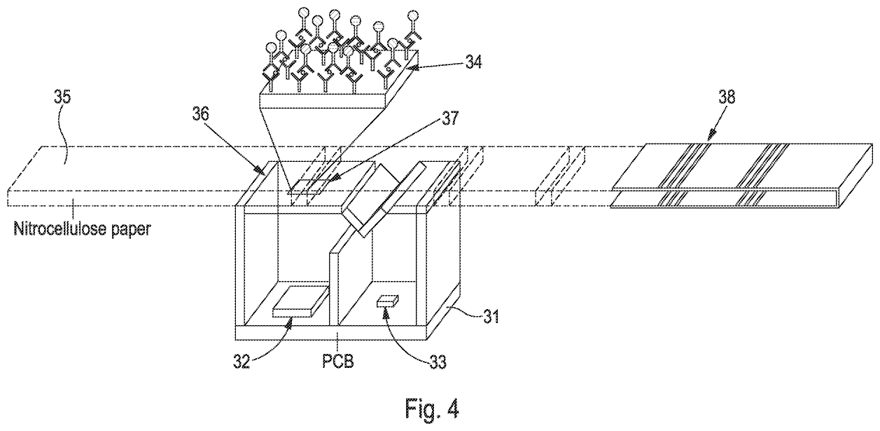

FIG. 4 illustrates a perspective view of the schematic cross section of FIG. 3. showing additional optional structural features. As in FIG. 3, the PCB 31 holds a first detector 32, for example a multi spectral sensor, and one light source 33, which may be, for example, a broadband, white or any other colour LED depending on the illumination requirements of the tagged analytes 34 present on the lateral flow test strip 35, which may be for example for example a nitrocellulose paper strip.

Arranged on the PCB 31 is also one or more walls 36 which may serve the same purposes as the walls described above in relation to FIG. 2. However, unlike in FIG. 2, only one aperture 37 is present such that only one test line or zone may be read at a single time. Instead, the test lines or zones are read out in sequence by moving the lateral flow test strip 35 over the aperture, as described above in relation to FIG. 3. As in FIG. 3, alignment markers 38 may be added to the lateral flow test strip 35 to indicate for instance a beginning and end thereof.

Whilst the example configuration of FIG. 4 has three test lines, it is envisaged that any other number of test lines may also be present. For instance in an array of test dots.

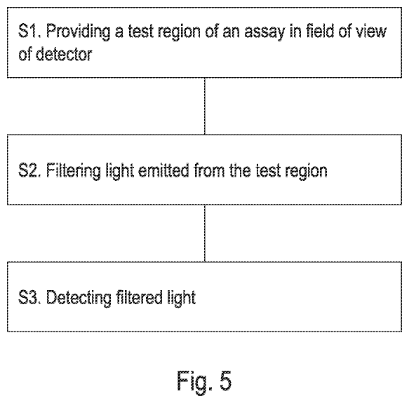

FIG. 5 is a flow diagram illustrating the general method described herein. The method comprises the steps of S1 providing the test region of the assay in the field of view of an optical detector, S2 filtering light emitted from the test region and S3 detecting the filtered light with the optical detector.

The invention may also be described as follows:

In the following description the word ‘detector’ (singular) is used and the skilled person understands that this may refer to a detector with an array of photodiode sensor pixels whereby different pixels are coated with different optical filters.

The disclosure describes an electronic optical readout for increased sensitivity, for multi-analyte detection and for the quantification of the analyte of interest.

Lateral flow tests, also known as lateral flow immunochromatographic assays, are simple devices intended to detect the presence (or absence) of a target analyte in a sample (matrix) without the need for specialized and costly equipment, though many lab based applications exist that are supported by reading equipment. Typically, these tests are used for medical diagnostics either for home testing, point of care testing, or laboratory use. A widely spread and well known application is the home pregnancy test.

The technology is based on a series of capillary beds, such as pieces of porous paper, microstructured polymer, or sintered polymer. Each of these elements has the capacity to transport fluid (e.g., urine) spontaneously.

The first element (the sample pad) acts as a sponge and holds an excess of sample fluid. Once soaked, the fluid migrates to the second element (conjugate pad) in which the manufacturer has stored the so-called conjugate, a dried format of bio-active particles in a salt-sugar matrix that contains everything to guarantee an optimized chemical reaction between the target molecule (e.g., an antigen) and its chemical partner (e.g. antibody) that has been immobilized on the particle's surface. While the sample fluid dissolves the salt-sugar matrix, it also mobilizes the particles and in one combined transport action the sample and conjugate mix while flowing through the porous structure. In this way, the analyte binds to the particles while migrating further through the third capillary bed. This material has one or more areas (often called stripes or dots) where a third molecule has been immobilized by the manufacturer. By the time the sample-conjugate mix reaches these strips, analyte has been bound on the particle and the third ‘capture’ molecule binds the complex. After a while, when more and more fluid has passed the stripes, particles accumulate and the stripe-area changes color. Typically there are at least two stripes:
1. one (the control) that captures any particle and thereby shows that reaction conditions and technology worked fine,
2. the second contains a specific capture molecule and only captures those particles onto which an analyte molecule has been immobilized. This makes the diagnostic result of the test visible for the patient.

After passing these reaction zones the fluid enters the final porous material, the wick that simply acts as a waste container.

There are currently three kinds of lateral flow tests.

Type 1: lateral flow tests without any electronics. One should “read” a colour change with your naked eye. This cannot be done in a sensitive or quantitative way. You can only achieve a binary readout, namely yes or no. For a lot of diseases quantification is important which cannot be achieved with your naked eye. Therefore these types of tests are generally not commercially available for diagnostics which require quantification or sensitive analysis.

Type 2: lateral flow tests with an external optical readout. This results in an increased level of quantification and an increased sensitivity. However, one needs to have an external reader device which is for consumer applications sometimes a disadvantage. Furthermore, an external device means that the distance between the colour change and the detector is larger than with a closely integrated device, where the detector is closely connected to the place where the colour change takes place. An increased distance between the colour change and the detector. This can result in a decreased signal or the need to use a more expensive detector.

Type 3: lateral flow tests with integrated optical readout containing the light sources and the detectors is a third class of lateral flow test reading methodologies. The advantage of these kind of readout systems: quantification is possible and an increased sensitivity can be achieved without the need of an external detector. However, multi-analyte detection is difficult, since one needs additional light sources and detectors if one wants to measure different kinds of analytes e.g. different kind of lines.

The foregoing issue is solved by using a detector with different kinds of filters to measure different kinds of colours at the same time and quantify these different colours. This has the advantage that only one detector is necessary for detecting different kinds of analytes, e.g., different kinds of colours. Furthermore, the proposed concept has some additional advantages. Current electronic readout systems for lateral flow tests typically have an extra detector to reference the background light or to reference the membrane which did not change its colour. In the current invention, one could have three colour filters on one detector which give one the ability to measure three different colours. In addition, one could have a fourth region without any filters to check the background light or to check the light intensity of the LED or to check a reference area on the strip/membrane. The light source could also be integrated in the middle of these four filter zones which allows to miniaturize the whole readout even more.

The above concepts would also allow one to follow the kinetics of the affinity reaction which can also give one additional information on the biological assay.

These concepts are applicable for both type 2 detecting as well as type 3 detection. However, type 3 detection can provide additional advantages as noted above.

In another configuration, only one light source and one detector can be used. In this case, the configuration can be as follows:
One detector and one light source on a PCB (printed circuit board)
A strip with the “developed” strips/colour lines is moved over the detector.
The detector could quantify the light intensity of the colour line.

This configuration has some advantages compared to the previous concept:
In this configuration the kinetics cannot be followed online. However, only endpoint analysis is possible
Fewer components are necessary—Only one light source and one detector.

Depending on the end application, the most useful configuration can be chosen.

Besides the readout, the PCBs can be complemented with one of more additional components: a microcontroller, wireless configurations, memory, etc. . . . .

Alternatively, the above-mentioned features can be implemented in a specific ASIC.

Consider, as an example, a classical lateral flow tests with two red lines. One or two detectors should be positioned above or beneath the lines depending on reflection mode or absorption mode. The detector has four zones:
A first zone to measure white light to compensate for background light or LED or to measure a reference zone on the strip
A second zone which measures a red color originating from analyte 1 being present
A third zone which measures a green color originating from analyte 2 being present
A fourth zone which measures a blue color originating from analyte 3 being present

The test build up is as follows:
The conjugate pad contains three different dyes
The control line contains three different receptors
The control line (one single line) will color red if only analyte 1 is present, will color green if only analyte 2 is present, will color blue if only analyte 3 is present, and will give a mixture of red, green and blue if a mixture of analytes is present in the sample. By measuring the intensity of the RGB signals, a discrimination of the different analytes can be identified and quantified

The advantages of this approach:
No additional detector for an ambient light measurement
No additional light source for ambient light measurement
Multiplexing without the need for more spots, more lines, more detectors

The above can be realized using a photodiode, or by using a Single Photon Avalanche Detector (SPAD) for more sensitive signals.

Even higher multiplex capabilities can be achieved using a spectral sensing chip.

To increase further the sensitivity and or to avoid a difficult optical setup, the above methodology also can be used in combination with lenses, e.g., in a known build-up of optical setups.

In this example, barrier structures are used to avoid cross contamination of the light. In our invention, we propose to align the light onto the detector using lens structures. This canl have the advantage that one can measure potentially closer to the detector lines (increased sensitivity), that the light can be focused onto the detector (increased sensitivity) and the ability to make the whole setup simpler and smaller.

The above concepts describe a readout based on transmission or reflection mode. For these applications, one needs to use a probe/dye with absorption characteristics.

However, some of the current diagnostic assays use also fluorescence or even luminescence readout mechanisms. For fluorescence, one needs a light source. As a light source VCELS or LEDs could be used. These light sources can have a specific color. Alternatively, they can have a broader spectrum and the light source can be pulsed. Alternatively, the light source can have a specific color and be pulsed.

The above concepts can also be used with an array detector to increase the amount of lines that can be detected. In this way, the multiplexing capabilities can be further increased.

A technique to measure flow rate, in combination with the above methodologies, can provide additional advantages and allow more accurate quantitative measurements.

General advantages of the described concepts:
Easier optical setup=cheaper device
Less components=cheaper device
Multi-analyte detection due to different color detection
Higher sensitivity due to SPADs
Quantitative measurements due to flow rate measurements
Or a combination of the above mentioned advantages

The previous concept also allows an increase in the dynamic range. One can use different kind of nanoparticles on the conjugate receptors. They would all have a different color and can therefore be discriminated when they bind onto the control/sample line. Their difference in for example affinity make them useful in another dynamic range. However, since they have a different color, one can measure them simultaneously and increase the dynamic range.

Additionally a paper tracking function can be built in the same color detecting ASIC to check the position of the lateral flow test strip. The lateral flow test contains recognizable position tracking, including begin & end signs of the strip. This paper tracking function is similar as a computer mouse position function.

Hence the ASIC-chip contains the following modules:
1. Color sensor
2. Paper tracking modality
3. A LED as light source
4. A wireless configuration e.g. Bluetooth, WIFI, NFC
5. A state machine or microprocessor for calculations etc.

A combination of the above-mentioned options is also possible.

In summary: a single detector to measure the background signal (or reference signal) and to measure different colours reduces the amount of detectors needed and allows for multi-analyte detection in a quantitative way upon reading the intensity of the different colours. An additional paper tracking function can adopt for lateral flow tests with colouring bands (analytes) at different locations on the lateral flow test strip. Features include:
Optical electronic readout for lateral flow tests using a spectral sensor detector.
Lateral flow test tracking function.

The invention can, in some implementation, provide one or more advantages:
Allows sensitive and quantitative measurements
No additional detector needed to compensate for ambient light or to reference against a non-modified strip
No additional light source necessary to measure the background signal of the membrane
Allows for multi-analyte detection or multicolour measurements without the need for additional lines or more detectors
It does not require manufactures of lateral flow tests to change their well-defined and understood fabrication methods.
The high sensitivity allows detection of biomarkers (and thus the corresponding diseases) previously not possible with eye-read lateral flow test.

Examples of applications in which the invention can be used:
Spectral sensing detectors
CMOSIS array capabilities
Lens systems
VCELS

Combinations of features (examples):
1. Quantitative readout photodiode chip which can detect different colors. This allows multi-analyte detection and/or background compensation for absorbance measurements
2. 1+with SPAD
3. Above for luminescence measurements
4. Above+lenses
5. Above+VCELS for fluorescence measurements
6. Above+flow rate measurement
7. 1+moving strip & all the other combinations mentioned above

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. Apparatus for reading a test region of an assay, the apparatus comprising:
an optical detector, comprising an optical input for receiving light emitted from the test region of the assay and an electrical output;
an electrical signal processor, electrically coupled to the electrical output; and
a plurality of spectral filters substantially transparent to a plurality of different wavelengths.

2. The apparatus of claim 1, wherein the spectral filters are arranged in front of the optical input of the optical detector and wherein the plurality of spectral filters correspond to a plurality of spatially separated regions of the optical detector.

3. The apparatus of claim 2, wherein the optical detector comprises a main optical axis for receiving an incoming optical signal, and wherein the plurality of regions are arranged in a plane substantially perpendicular to the main optical axis.

4. The apparatus of claim 1, wherein the plurality of spectral filters further comprise a reference portion, which has an optical transmission spectrum which is broader than the transmission spectrum of said plurality of different wavelengths.

5. The apparatus of claim 1, wherein the optical detector is a spatially resolved optical detector with a spatial resolution larger than the number of said plurality of spectral filters.

6. The apparatus of claim 1, wherein the optical detector comprises an array of detectors, and wherein each detector of the array of detectors corresponds to each of said plurality of spectral filters.

7. The apparatus of claim 1, wherein the optical detector comprises said plurality of spectral filters.

8. The apparatus according to claim 1, further comprising a light source for illuminating the test region.

9. The apparatus according to claim 8, wherein the optical detector comprises a field of view, and wherein the light source is arranged outside the field of view of the optical detector.

10. The apparatus according to claim 1, further comprising an optical component arranged to block a portion of the light emitted or reflected from the test region of the assay.

11. The apparatus according to claim 10, wherein the optical component is a diaphragm.

12. The apparatus according to claim 1, further comprising a device for measuring lateral displacement of the test region.

13. The apparatus according to claim 12 comprising one of: a wheel, a ball or an optical tracking device.

14. A method for reading a test region of an assay, the method comprising
providing the test region of the assay in the field of view of an optical detector,
filtering light emitted from the test region using a plurality of optical filters with different transmission spectra to provide filtered light
detecting the filtered light with the optical detector.

15. The method according to claim 14, further comprising spectrally resolving transmitted light corresponding to the plurality of different transmission spectra with the optical detector.

16. The method according to claim 14, further comprising measuring a background optical signal using a filter with a broadband transmission spectrum.

17. The method according to claim 14, further comprising illuminating the test region.

18. The method according to claim 14, further comprising moving the test region with respect to the optical detector and measuring a time dependency of the filtered light.

19. The method according to claim 14, wherein said detecting the filtered light further comprises detecting a fluorescence signal.

20. The method according to claim 19, wherein said detecting a fluorescence signal comprises resolving the fluorescence signal in time.
